(19) United States
(12) Patent Application Publication
(10) Pub. No.: US 2010/0088097 A1
(43) Pub. Date: Apr. 8, 2010

(54) USER FRIENDLY SPEAKER ADAPTATION FOR SPEECH RECOGNITION

(75) Inventors: Jilei Tian, Tampere (FI); Janne Vainio, Pirkkala (FI); Jussi Leppanen, Tampere (FI); Hannu Mikkola, Tampere (FI); Juha Marila, Harjavalta (FI)

Correspondence Address: BANNER & WITCOFF, LTD., 1100 13th STREET, N.W., SUITE 1200, WASHINGTON, DC, 20005-4051, US

(73) Assignee: Nokia Corporation, Espoo (FI)

(21) Appl. No.: 12/244,919

(22) Filed: Oct. 3, 2008

(51) Int. Cl. G10L 15/00

(52) U.S. Cl. 704/251; 704/E15.001

(57) ABSTRACT

Improved performance and user experience for speech recognition application and system by utilizing for example offline adaptation without tedious effort by a user. Interactions with a user may be in the form of a quiz, game, or other scenario wherein the user may implicitly provide vocal input for adaptation data. Queries with a plurality of candidate answers may be designed in an optimal and efficient way, and presented to the user, wherein detected speech from the user is then matched to one of the candidate answers, and may be used to adapt an acoustic model to the particular speaker for speech recognition.

### FIELD

The invention relates generally to speech recognition. More specifically, the invention relates to speaker adaptation for speech recognition.

### BACKGROUND

Mobile phones have been widely used for reading and composing text messages including longer text messages with the emergence of email and web enabled phones. Due to the limited keyboard on most phone models, text input has always been awkward compared to text input on a desktop computer. Furthermore, mobile phones are frequently used in “hands free” environments, where keyboard input is difficult or impossible. Speech input can be used as an alternative input method in these situations, either exclusively or in combination with other text input methods. Speech dictation by natural language is thus highly desired. The technology in its general form, however, remains a challenging task partly due to the recognition performance especially in mobile device environments.

For speech recognition, speaker independence (SI) is a much desired feature, especially for development of products for the mass market. However, SI is very challenging, even for audiences with homogeneous language and accents. Speaker variability is a fundamental problem in speech recognition. It is especially challenging in a mobile device environment. Adaptation to the speaker's vocal characteristics and background environment may greatly improve speech recognition accuracy, especially for a mobile device that is more or less a personal device. Adaptation typically involves adjusting an acoustic model for a general, speaker independent (SI) model to a model adapted for the specific speaker, a so-called speaker dependent (SD) model. More specifically, the acoustic model adaptation typically updates the original speaker independent acoustic model to a particular user's voice, accent, and speech pattern. The adaptation process helps “tune” the acoustic model using speaker-specific data. Generally, improved performance can be obtained with only a small amount of adaptation data.

However, most of the current efficient SD adaptation models require the user to explicitly train his or her acoustic model by reading prepared prompts, usually comprising a certain number of sentences. When this is done before the user can start using the speech recognition or dictation system, this is referred to as offline adaptation (or training). Another term for offline adaptation is enrollment. For this process, the required number of sentences can range in the 20-100 (or higher) range, in order to create a reasonably adapted SD acoustic model. This is referred to as supervised adaptation, in that the user is provided with predefined phrases or sentences, which is beneficial because the speech recognition system knows exactly what it is hearing, without ambiguity. Offline supervised adaptation can result in high initial performance for the speech recognition system, but comes with the burden of requiring users to perform a time-consuming and tedious task before utilizing the system.

Some acoustic model adaptation procedures attempt to avoid this tedious task by performing online adaptation. Online adaptation generally involves performing actual speech recognition, while at the same time performing incremental adaptation. The user dictates to the speech recognition application, and the application performs adaptation against the words that it recognizes. This is known as unsupervised adaptation, in that the speech recognition system does not know what speech input it will receive, but must perform error-prone speech recognition prior to adaption. From the usability point of view, incremental online adaptation is very attractive for practical applications because it can hide the adaptation process from the user. Online adaptation doesn't cause extra effort for a user, but the speech recognition system can suffer from poor initial performance, and can require extra computational load and a long adaptation period before reaching good or even adequate performance.

User experience testing has shown that the users are quite reluctant to carry out any intensive enrollment steps. However in order to provide adequate performance, most speech recognition systems require a new user to explicitly train his or her acoustic models through enrollment. Speech recognition systems and applications would be more accepted if good performance could be achieved.

### BRIEF SUMMARY

The following presents a simplified summary in order to provide a basic understanding of some aspects of the invention. This summary is not an extensive overview of the invention. It is not intended to identify key or critical elements of the invention or to delineate the scope of the invention. The following summary merely presents some concepts of the invention in a simplified form as a prelude to the more detailed description provided below.

An embodiment is directed to a novel solution to implicitly achieve the adaptation process for improving speech recognition performance and a user experience.

An embodiment improves the speech recognition performance through offline adaptation without tedious effort by a user. Interactions with a user may be in the form of a quiz, game, or other scenario wherein the user may provide vocal input usable for adaptation data. Queries with a plurality of candidate answers may be presented to the user, wherein vocal input from the user is then matched to one of the candidate answers.

An embodiment includes a method comprising presenting a query to a user, presenting to the user a plurality of possible answers or answer candidates to the query, receiving a vocal response from the user, matching the vocal response to one of the plurality of possible answers presented to the user, and using the matched vocal response to adapt an acoustic model for the user for a speech recognition application. The method may include selecting the query based on phonetic content of the possible answers, or selecting the query based on an interactive game for the user. Embodiments may include repeating this process multiple times.

Embodiments may comprise wherein matching the vocal response includes performing a forced alignment between the vocal response and one of the plurality of possible answers to the query; or selecting a potential match, and receiving a confirmation from the user that the potential match is correct. The plurality of possible answers to the query may be phonetically balanced, and/or substantially phonetically distinguishable. The possible answers may be created to minimize an objective function value among the list of potentially possible answers.

Embodiments may include wherein the process of matching the vocal response to one of the plurality of possible answers includes determining if one of the plurality of possible answers exceeds an adaptation threshold. A matched vocal response may be used for adaptation only if the matched vocal response exceeds a predetermined threshold value. The predetermined threshold value may adjust a quality of the matched vocal responses used to adapt the acoustic model.

An embodiment may include an apparatus comprising a processor, and a memory, including machine executable instructions, that when provided to the processor, cause the processor to perform presenting a query to a user, presenting to the user a plurality of possible answers to the query, receiving a vocal response from the user, matching the vocal response to one of the plurality of possible answers presented to the user, and using the matched vocal response to adapt an acoustic model for the user for a speech recognition application. Selecting the query may be based on phonetic content of the possible answers, and/or based on an interactive game for the user. An example apparatus includes a mobile terminal.

An embodiment may include a computer program that performs presenting a query to a user; presenting to the user a plurality of possible answers to the query; receiving a vocal response from the user; matching the vocal response to one of the plurality of possible answers presented to the user; and using the matched vocal response to adapt an acoustic model for the user for a speech recognition application. The computer program may include selecting the query based on phonetic content of the possible answers, and/or based on an interactive game for the user. For matching the vocal response, the computer program may include performing a forced alignment between the vocal response and one of the plurality of possible answers to the query. This may also include receiving a confirmation from the user for a selected potential match.

Embodiments may include a computer readable medium including instructions that when provided to a processor cause the processor to perform any of the methods or processes described herein.

Advantages of various embodiments include improved recognition performance, and improved user experience and usability.

### BRIEF DESCRIPTION OF THE DRAWINGS

A more complete understanding of the present invention and the advantages thereof may be acquired by referring to the following description in consideration of the accompanying drawings, in which like reference numbers indicate like features, and wherein:

FIG. 1 illustrates a graph showing results of an experiment using different adaptation methods;

FIG. 2 illustrates a process performed by an embodiment of the present invention; and

FIG. 3 illustrates an apparatus for utilizing an embodiment of the present invention.

### DETAILED DESCRIPTION

In the following description of the various embodiments, reference is made to the accompanying drawings, which form a part hereof, and in which is shown by way of illustration various embodiments in which the invention may be practiced. It is to be understood that other embodiments may be utilized and structural and functional modifications may be made without departing from the scope of the present invention.

Typically, large vocabulary automatic speech recognition (LVASR) systems are initially trained on a speech database from multiple speakers. For improved performance for individual users, online and/or offline speaker adaptation is enabled in either a supervised or an unsupervised manner. Among other things, offline supervised speaker adaptation can enhance the following online unsupervised adaptation as well as improve the user's first impression of the system.

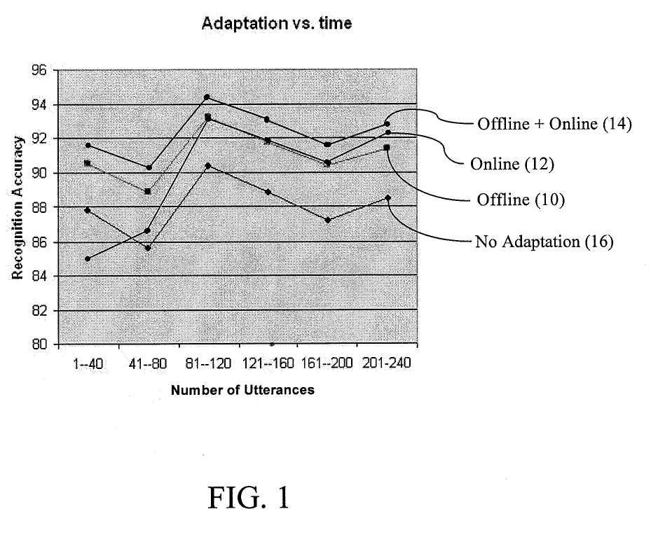

The inventors performed experiments to benchmark the recognition performance using acoustic Bayesian adaptation, as is known in the art. The test set used in the experiments contained a total of 5500 SMS (short message service) messages from 23 US English speakers (male and female) with 240 utterances per speaker. The speakers were selected so that different dialect regions and age groups were well represented. For supervised adaptation, thirty enrollment utterances were used. Results from such an experiment are shown in FIG. 1.

In interpreting these results, it is clear that adaptation plays a role for improving the recognition accuracy. Recognition without any adaptation is shown by line 16, which shows the accuracy varying over the experiment, but it is low and does not improve. Offline supervised adaptation (line 10) offers immediate significant improvement when starting speech recognition. In general, offline supervised adaptation can bring good initial recognition performance, especially since users may quickly give up on using a new application with perceived bad performance. Online unsupervised adaptation (line 12) shows poor initial performance, but catches up to the offline performance after 100-200 utterances. It also indicates that the efficiency of offline supervised adaptation is about 3 times higher than online unsupervised adaptation, in that approximately 100 online adaptation utterances were needed to reach similar recognition performance that was achieved using only 30 offline supervised adaptation utterances. This may in part be due to reliable supervised data and phonetically rich selections for offline adaptation. Online adaptation starts approaching the level of combined offline and online adaptation (line 14) after approximately 200 utterances. Combined offline supervised and online unsupervised adaptation (line 14) brings the best performance, both initially and after online adaptation.

However, both offline and online adaptation may have disadvantages. Supervised offline adaptation can be boring and tedious for the user since the user must read text according to displayed prompts. Unsupervised online adaptation may bring initial low efficiency, and system performance may only improve slowly because unsupervised data is erroneous and may not provide the phonetic variance necessary to comprehensively train the acoustic model.

An embodiment of the present invention includes an adaptation approach that can benefit both supervised and unsupervised adaptation, while avoiding certain drawbacks of each. Embodiments can have similar performance to supervised offline adaptation, but be implemented in a similar fashion as unsupervised adaptation. This is possible because an embodiment may perform speech recognition in a manner similar to unsupervised adaptation, but using a limited number of answer sentences or phrases. Since the user selects the answer by reading one of the provided answer candidates, the recognition task becomes an identification task within a limited set of provided answer candidates, thus perfect recognition may be achieved, with performance similar to supervised adaptation. Further, as it can be carried out as unsupervised adaptation within a limited number of sentences or phrases and users aren't forced to mechanically read the given prompts, it can thus add more fun factor in the adaptation procedure. Instead a sense of fun and involvement may be introduced, thereby motivating users. A pleasurable user experience may result from an enjoyable and challenging experience. An embodiment introduces a fun factor and reduces the boring experience by converting a boring enrollment session into a game domain. Enrollment data can be collected implicitly through the speech interaction between the user and the system or device during a game-like approach.

An embodiment of the present invention integrates an enrollment process into a game-like application, for example a quiz, a word game, a memory game or an exchange of theatrical lines. As one example, an embodiment will offer a user at least two alternative sentences to speak at a step of the adaptation process. Given a predefined quiz and alternative candidate answers, a user speaks one of the answers. An embodiment operates the recognition task in a very limited search space with only a few possible candidate answers, thereby limiting the processing power and memory requirements for recognizing one of the candidate answers. Therefore this embodiment performs in an unsupervised adaptation manner, yet with almost supervised adaptation performance since the recognition task becomes the identification task with only a few candidate sentences leading to improved performance, but with a gaming fun factor. Therefore this embodiment has an advantage of minimal effort required for adaptation.

An embodiment may simply ask or display a list of questions one by one. As an example, the embodiment may pose a question followed by a set of prompts with possible candidate answers. The user would select and speak one of the prompts. In the following example, only two prompts are shown for simplicity, however an embodiment may include reasonable number of provided prompts:

Question 1:

What is enrollment in speech recognition?

### Answer Candidates:

W_{aNs1}: Making registration in the university
Wₐₙₛ₂: Learn the individual speaker's characteristics to improve the recognition performance. etc.

For the given question, the user speaks one of the possible answers. Then the embodiment automatically identifies the user's selected answer from the detected speech. An embodiment may identify the answer by forced alignment against the user's speech for all answer candidates. The forced alignment infers which candidate option (S) the user has spoken between answer candidate 1 (Wₐₙₛ₁) and answer candidate 2 (Wₐₙₛ₂). The decision is based on the likelihood ratio R:

$$R ( {W}_{ans 1} , {W}_{ans 2} , S ) = \frac{P ( {W}_{ans 1} \vert S )}{P ( {W}_{ans 2} \vert S )} = \frac{P ( S \vert {W}_{ans 1} ) \cdot P ( {W}_{ans 1} )}{P ( S \vert {W}_{ans 2} ) \cdot P ( {W}_{ans 2} )} \qquad ( 1 )$$

The P(Wₐₙₛ₁) and P(Wₐₙₛ₂) are estimated using a language model (LM). The language model assigns a statistical probability to a sequence of words by means of a probability distribution to optimally decode the sentences given the word hypothesis from a recognizer. On the other hand, the LM tries to capture the properties of a language, model the grammar of the language in the data-driven manner, and to predict the next word in a speech sequence. In the case of forced alignment, the LM score may be omitted because all sentences are pre-defined. Therefore P(Wₐₙₛ₁|S) and P(Wₐₙₛ₂|S) may be calculated for example using a Viterbi algorithm, as is known in the art. The detected speech may be admitted as adaptation data if

R(Wₐₙₛ₁,Wₐₙₛ₂,S)≧T (2)

Wherein the threshold T can be heuristically set to achieve improved performance using the training corpus. Changing the threshold can adjust the aggressiveness for collecting adaptation data, thus controlling the quality of the adaptation data. This approach can also integrate into online adaptation to verify the quality of the data. The high quality adaptation data can be collected with high confidence if the threshold is set high.

To aid in matching the detected speech to one of the responses, the candidate responses or answers may be ranked in order based on a likelihood of matching the detected speech. The candidate answer with the highest score may be highlighted, or pre-selected for quick confirmation by the user. This optional confirmation may be performed using any type of user input, for example by a touch screen, confirmation button, typing, or a spoken confirmation. If the highlighted candidate is the user's answer, then it is collected as qualified adaptation data; otherwise an embodiment may select the second possible answer in the candidate answer list. It can, of course, always select the best candidate answer automatically based on the ranked scores.

Based on the collected adaptation data, the question selection algorithm may decide the next question based on an objective of efficiently collecting the best data for adaptation, e.g. phonetic balancing, most discriminative data, etc.

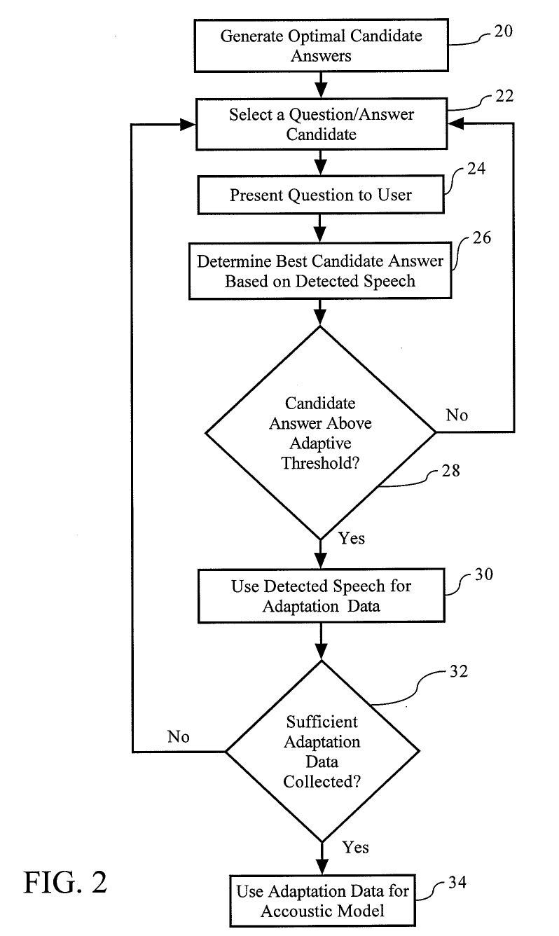

A process as performed by an embodiment is shown in FIG. 2. A first step is to generate a set of optimal questions and corresponding candidate answers, step 20. This step may be performed during the preparation or creation of an embodiment, with the questions and candidate answers then stored for use when the embodiment interacts with a user. For a given question, there will be several candidate answers for the user's selection. For some cases, some phonemes may occur more frequently than others. This unbalanced phoneme distribution can be problematic for an acoustic model adaptation. Therefore, for supervised adaptation, it is helpful to efficiently design adaptation text with phonemes assuming a predefined balanced distribution. For optimal performance, each candidate answer may be designed to achieve a phonetically balanced phrase or sentence.

Further, all candidate answers for a given question may be as phonetically distinguishable as possible, to ease automatic answer selection, for example using forced alignment as depicted in Equations (1) and (2). If the candidate answers are designed in such a way that they are not acoustically confusable, the automatic identification error can be greatly reduced, which may lead to better performance. For example, two confusable candidate answers would be: “do you wreck a nice beach” and “do you recognize speech”. It would be difficult for candidate answer identification while automatically selecting the correct candidate answer from the user's speech. One possible approach is to predefine a large list of possible answers. Then a statistical approach can be applied to select the best candidate answers from the potential predefined large list based on a criterion of collecting efficient adaptation data. For example, given a candidate answer, its Hidden Markov Model (HMM) can be formed to concatenate all its phonetic HMMs together. Then a distance measurement between the HMMs for the two candidate answers can be used to measure the confusion between them.

An objective function G may be defined to measure the distribution match between predefined ideal phoneme distribution and the distribution of the adaptation candidate answers used to approximate it. The predefined ideal phoneme distribution usually assumes uniform or other task specific distribution. A cross entropy (CE) approach may measure the expected logarithm of the likelihood ratio, and is a widely-used measure to depict similarity between two probability distributions. The CE may be considered the ideal distribution P when P′ is the distribution of the candidate adaptation sentences used to approximate it. In the following equation, M is the number of phonemes.

$$G ( P , {P}^{′} ) = {\sum }_{m = 1}^{M} {P}_{m}^{′} \cdot log \frac{{P}_{m}^{′}}{P} \qquad ( 3 )$$

The objective function G is minimized with respect to P in order to get a best approximation to the ideal distribution in the discrete probability space. Thus the best adaptation question/answer can be designed or selected based on the optimizing objective function G. An alternative embodiment may include that one question/answer is added at a time until an adaptation sentence requirement N is reached. A question/answer is selected at each time so that the newly formed adaptation set has the minimum objective function G.

At step 22 the embodiment selects a candidate question/answer. The selection process may be determined for example based on the phonemes presented in the candidate answer, in order to obtain speech from the user that covers all required phonemes to properly adapt the speech model. In other embodiments, the selection process may be driven by the presentation or game being presented to the user.

At step 24, the question is presented to the user. In some embodiments, the presentation may be designed in the form of a quiz-driven interaction game or games. Examples include popular song lyrics, world history, word games, IQ tests, technical knowledge (such as the previous example regarding speech recognition) and collecting user information (age, gender, education, hobbies, or preferences). Candidate answers may also be in the form of prompts to control an interactive game that responds to voice commands. Several games may be offered to the user to choose from, to generate more adaptation data through many games. Such games may be presented as separate applications, such as speech games. Further, other embodiments include system utilities or applications, for example collecting operating system, application, or device configurations, settings, or user preferences where a user may be provided with predefined multiple answer candidates, and wherein an acoustic model may get trained in the background. Other embodiments include login systems, tutorials, help systems, application or user registration processes, or any type of application or utility where predefined multiple choice inputs may be presented to a user for selection. In any embodiment, the link to the speech recognition adaptation process does not need to be explicit, or even mentioned. Embodiments may simply be presented as entertainment and/or utility applications in their own right.

Upon receiving detected speech from a user, an embodiment determines the best matching candidate answer, step 26, as previously described, including the process described using Equations (1) and (2). At step 28, the adaptive data threshold may be confirmed, for example using Equation (2). The threshold factor is used to measure the confidence or reliability that the selected answer is correct. The threshold may be adaptively adjusted depending on how phonetically close two or more possible candidate answers are, for example by using the objective function G defined above. Also as previously described, potential candidate answer(s) may be shown to the user for verification, possibly as part of the quiz application. In such a case, an adaptive threshold determination may not be necessary.

If the candidate answer is not above the adaptive threshold, step 28, the adaptive data may be discarded and the process returns to question/answer selection process, step 22, to select another question. If the adaptive data meets the adaptive threshold, the detected speech may then be used for adaptation data, step 30.

The adaptation process may continue until sufficient adaptive data has been collected, step 32. If a stopping criterion is achieved, the collection process may terminate, step 34 and the collected adaptation data may then be used to train the acoustic model. Alternatively, the process may continue so a user may finish playing the quiz or game. A stopping criterion can be defined manually, such as predefined number of adaptation sentences N. It can also be determined automatically using for example the objective function G, as determined by Equation (3). When G has attained a minimum value, then the adaptation data collection may be terminated. A stopping criterion can also be determined by adaptive acoustic model gain, for example the adaptation process may be terminated if the adapted acoustic model has little to no change before and after adaptation.

An embodiment may be based on an action game with prompts that may be visually displayed for a user's interaction through speech. An embodiment may be designed for multiple users. Each user is assigned with a unique user ID or name, such as “owner”, “guest”, etc. The scores are calculated to each user when the game is over, meanwhile the speaker-dependent speech adaptation data is collected for the proper acoustic model adaptation for that user.

Embodiments may be utilized for offline adaptation, online adaptation, or for both. Further, embodiments may be utilized for any speech recognition application or utility, whether a large system with large vocabularies running on fast hardware, or a limited application running on a device with limited vocabulary.

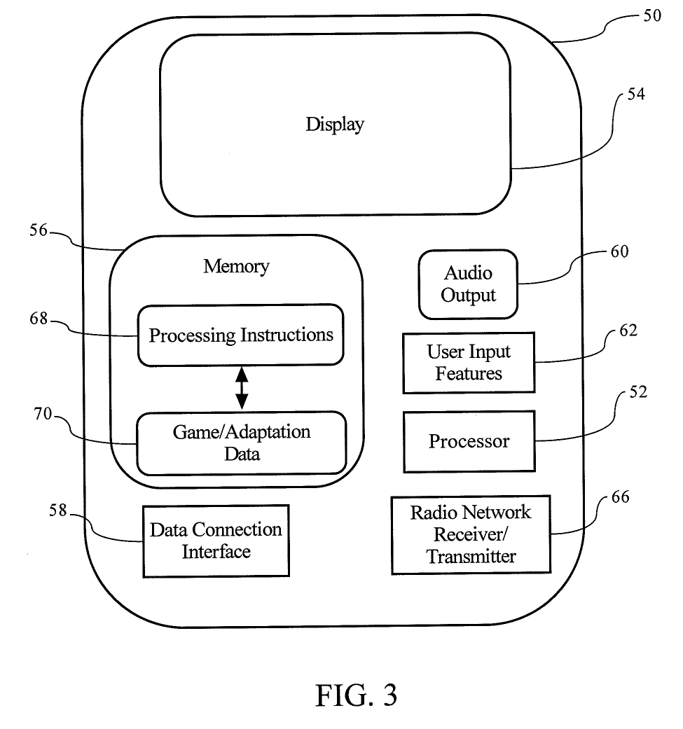

Embodiments of the present invention may be implemented in any type of device, including computers, portable music/media players, PDAs, mobile phones, and mobile terminals. An example device comprising a mobile terminal 50 is shown in FIG. 3. The mobile terminal 50 may comprise a network-enabled wireless device, such as a cellular phone, a mobile terminal, a data terminal, a pager, a laptop computer or combinations thereof. The mobile terminal may also comprise a device that is not network-enabled, such as a personal digital assistant (PDA), a wristwatch, a GPS receiver, a portable navigation device, a car navigation device, a portable TV device, a portable video device, a portable audio device, or combinations thereof. Further, the mobile terminal may comprise any combination of network-enabled wireless devices and non network-enabled devices. Although device 50 is shown as a mobile terminal, it is understood that the invention may be practiced using non-portable or non-movable devices. As a network-enabled device, mobile terminal 50 may communicate over a radio link to a wireless network (not shown) and through gateways and web servers. Examples of wireless networks include third-generation (3G) cellular data communications networks, fourth-generation (4G) cellular data communications networks, Global System for Mobile communications networks (GSM), wireless local area networks (WLANs), or other current or future wireless communication networks. Mobile terminal 50 may also communicate with a web server through one or more ports (not shown) on the mobile terminal that may allow a wired connection to the Internet, such as universal serial bus (USB) connection, and/or via a short-range wireless connection (not shown), such as a BLUETOOTH™ link or a wireless connection to WLAN access point. Thus, mobile terminal 50 may be able to communicate with a web server in multiple ways.

As shown in FIG. 3, the mobile terminal 50 may comprise a processor 52, a display 54, memory 56, a data connection interface 58, and user input features 62, such as microphone, keypads, touch screens etc. It may also include a short-range radio transmitter/receiver 66, a global positioning system (GPS) receiver (not shown) and possibly other sensors. The processor 52 is in communication (not shown) with memory 56 and may execute instructions stored therein. The user input features 62 are also in communication with the processor 52 (not shown) for providing input to the processor. In combination, the user input 62, display 54 and processor 52, in concert with instructions stored in memory 56, may form a graphical user interface (GUI), which allows a user to interact with the device and modify displays shown on display 54. Data connection interface 58 is connected (not shown) with the processor 52 and enables communication with wireless networks as previously described.

The mobile terminal 50 may also comprise audio output features 60, which allows sound and music to be played. Further, as previously described, user input features 62 may include a microphone or other form of sound input device. Such audio input and output features may include hardware features such as single and multi-channel analog amplifier circuits, equalization circuits, and audio jacks. Such audio features may also include analog/digital and digital/analog converters, filtering circuits, and digital signal processors, either as hardware or as software instructions to be performed by the processor 52 (or alternative processor) or any combination thereof.

The memory 56 may include processing instructions 68 for performing embodiments of the present invention. For example such instructions 68 may cause the processor 52 to display interactive questions on display 54, receive detected speech through the user input features 62, and process adaptation data, as previously described. The memory 56 may include static or dynamic data 70 utilized in the interactive games and/or adaptation process. Such instructions and data may be downloaded or streamed from a network or other source, provided in firmware/software, or supplied on some type of removable storage device, for example flash memory or hard disk storage.

Additionally, the methods and features recited herein may further be implemented through any number of computer readable mediums that are able to store computer readable instructions. Examples of computer readable media that may be used comprise RAM, ROM, EEPROM, flash memory or other memory technology, CD-ROM, DVD or other optical disk storage, magnetic cassettes, magnetic tape, magnetic storage and the like.

One or more aspects of the invention may be embodied in computer-usable data and computer-executable instructions, such as in one or more program modules, executed by one or more computers or other devices. Generally, program modules comprise routines, programs, objects, components, data structures, etc. that perform particular tasks or implement particular abstract data types when executed by a processor in a computer or other device. The computer executable instructions may be stored on a computer readable medium such as a hard disk, optical disk, removable storage media, solid state memory, RAM, etc. As will be appreciated by one of skill in the art, the functionality of the program modules may be combined or distributed as desired in various embodiments. In addition, the functionality may be embodied in whole or in part in firmware or hardware equivalents such as integrated circuits, field programmable gate arrays (FPGA), and the like. Particular data structures may be used to more effectively implement one or more aspects of the invention, and such data structures are contemplated within the scope of computer executable instructions and computer-usable data described herein.

While illustrative systems and methods as described herein embodying various aspects of the present invention are shown, it will be understood by those skilled in the art, that the invention is not limited to these embodiments. Modifications may be made by those skilled in the art, particularly in light of the foregoing teachings. For example, each of the elements of the aforementioned embodiments may be utilized alone or in combination or sub combination with elements of the other embodiments. It will also be appreciated and understood that modifications may be made without departing from the true spirit and scope of the present invention. The description is thus to be regarded as illustrative instead of restrictive on the present invention.

Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims.

I/We claim:

1. A method comprising:
presenting a query to a user;
presenting to the user a plurality of possible answers to the query;
receiving a vocal response from the user;
matching the vocal response to one of the plurality of possible answers presented to the user; and
using the matched vocal response to adapt an acoustic model for the user for a speech recognition application.

2. The method of claim 1 further including selecting the query based on phonetic content of the possible answers.

3. The method of claim 1 further including selecting the query based on an interactive game for the user.

4. The method of claim 1 wherein matching the vocal response includes performing a forced alignment between the vocal response and one of the plurality of possible answers to the query.

5. The method of claim 1 wherein matching the vocal response includes selecting a potential match, and receiving a confirmation from the user that the potential match is correct.

6. The method of claim 1 wherein the plurality of possible answers to the query are phonetically balanced.

7. The method of claim 1 wherein the plurality of possible answers to the query are substantially phonetically distinguishable.

8. The method of claim 1 wherein the plurality of possible answers are created to minimize an objective function value among the plurality of possible answers.

9. The method of claim 1 wherein the process of matching the vocal response to one of the plurality of possible answers includes determining if one of the plurality of possible answers exceeds an adaptation threshold.

10. The method of claim 1 wherein the process of presenting a query, presenting a plurality of possible answers, receiving a vocal response, and matching the vocal response, is repeated multiple times.

11. The method of claim 4 wherein a forced alignment likelihood ratio (R) between the vocal response (S) and a first possible answer Wₐₙₛ₁ and a second possible answer Wₐₙₛ₂ is calculated using:
$$R ( {W}_{ans 1} , {W}_{ans 2} , S ) = \frac{P ( {W}_{ans 1} \vert S )}{P ( {W}_{ans 2} \vert S )} = \frac{P ( S \vert {W}_{ans 1} ) \cdot P ( {W}_{ans 1} )}{P ( S \vert {W}_{ans 2} ) \cdot P ( {W}_{ans 2} )} .$$

12. The method of claim 1 wherein the process of using the matched vocal response to adapt an acoustic model includes using the matched vocal response only if the matched vocal response exceeds a predetermined threshold value.

13. The method of claim 12 wherein adjusting the predetermined threshold value adjusts a quality of the matched vocal responses used to adapt the acoustic model.

14. An apparatus comprising:
a processor; and
a memory, including machine executable instructions, that when provided to the processor, cause the processor to perform:
presenting a query to a user;
presenting to the user a plurality of possible answers to the query;
receiving a vocal response from the user;
matching the vocal response to one of the plurality of possible answers presented to the user; and
using the matched vocal response to adapt an acoustic model for the user for a speech recognition application.

15. The apparatus of claim 14 further including instructions for the processor to perform selecting the query based on phonetic content of the possible answers.

16. The apparatus of claim 14 further including instructions for the processor to perform selecting the query based on an interactive game for the user.

17. The apparatus of claim 14 wherein matching the vocal response includes performing a forced alignment between the vocal response and one of the plurality of possible answers to the query.

18. The apparatus of claim 14 wherein matching the vocal response includes selecting a potential match, and receiving a confirmation from the user that the potential match is correct.

19. The apparatus of claim 14 wherein the plurality of possible answers to the query are phonetically balanced.

20. The apparatus of claim 14 wherein the plurality of possible answers to the query are substantially phonetically distinguishable.

21. The apparatus of claim 14 wherein the process of matching the vocal response to one of the plurality of possible answers includes determining if one of the plurality of possible answers exceeds an adaptation threshold.

22. The apparatus of claim 14 wherein the apparatus includes a mobile terminal.

23. A computer readable medium including instructions that when provided to a processor cause the processor to perform:
presenting a query to a user;
presenting to the user a plurality of possible answers to the query;
receiving a vocal response from the user;
matching the vocal response to one of the plurality of possible answers presented to the user; and
using the matched vocal response to adapt an acoustic model for the user for a speech recognition application.

24. The computer readable medium of claim 23 further including instructions for the processor to perform selecting the query based on phonetic content of the possible answers.

25. The computer readable medium of claim 23 further including instructions for the processor to perform selecting the query based on an interactive game for the user.

26. The computer readable medium of claim 23 including instructions wherein matching the vocal response to one of the plurality of possible answers includes determining if one of the plurality of possible answers exceeds an adaptation threshold.

27. An apparatus comprising:
means for presenting a query to a user;
means for presenting to the user a plurality of possible answers;
means for receiving a vocal response from the user;
matching means for matching a vocal response received from the user to one of the plurality of possible answers presented to the user; and
means for adapting an acoustic model for the user for a speech recognition application based on the matched vocal response.

28. The apparatus of claim 27 wherein the matching means includes means for performing a forced alignment between the vocal response and one of the plurality of possible answers.
